(19) United States
(12) Patent Application Publication
(10) Pub. No.: US 2014/0115148 A1
(43) Pub. Date: Apr. 24, 2014

(54) Decommission of a Server in Wireless Environment

(71) Applicant: INTERNATIONAL BUSINESS MACHINES CORP, Armonk, NY (US)

(72) Inventors: Tamer E. Abuelsaad, Poughkeepsie, NY (US); John E. Moore, Brownsburg, IN (US); Rajeshkumar N. Singi, Marietta, GA (US); Robert R. Wentworth, Round Rock, TX (US)

(73) Assignee: INTERNATIONAL BUSINESS MACHINES CORPORATION, Armonk, NY (US)

(21) Appl. No.: 13/671,718

(22) Filed: Nov. 8, 2012

Related U.S. Application Data
(63) Continuation of application No. 13/654,705, filed on Oct. 18, 2012.

(51) Int. Cl. H04W 24/00

(52) U.S. Cl. 709/224

(57) ABSTRACT

An embodiment of the invention provides a device for monitoring activity of a computing device wirelessly connected to a network, wherein the device includes a first interface for connecting the device to the computing device. A second interface wirelessly connects the device to the network. A sensor connected to the second interface measures wireless network traffic to the computing device and/or wireless network traffic from the computing device. Another embodiment of the invention provides a computing device having an interface for wirelessly connecting to a network. A sensor connected to the interface measures wireless network traffic to the computing device and/or wireless network traffic from the computing device. A processor connected to the sensor compares the network traffic to the computing device and/or the network traffic from the computing device to one or more thresholds to determine whether the computing device should be decommissioned.

This patent application is a continuation application of U.S. patent application Ser. No. 13/654,705 filed on Oct. 18, 2012, which is hereby incorporated by reference.

### BACKGROUND

The present invention is in the field of devices, systems, methods, and computer program products for the decommissioning of a server in a wireless environment.

A datacenter is a facility equipped with computing devices and electronic components. Datacenters have thousands of server devices. A rack server is a computing system including a plurality of server devices. In many cases these servers are managed remotely without physical access for many years (e.g., more than 10 years).

### SUMMARY OF THE INVENTION

An embodiment of the invention provides a device for monitoring activity of a computing device wirelessly connected to a network, wherein the device includes a first interface for connecting the device to the computing device. A second interface wirelessly connects the device to the network. A sensor connected to the second interface measures wireless network traffic to the computing device and/or wireless network traffic from the computing device.

Another embodiment of the invention provides a computing device having an interface for wirelessly connecting to a network. A sensor connected to the interface measures wireless network traffic to the computing device and/or wireless network traffic from the computing device. A processor connected to the sensor compares the network traffic to the computing device and/or the network traffic from the computing device to one or more thresholds to determine whether the computing device should be decommissioned.

Yet another embodiment of the invention provides a device for monitoring activity of a computing device connected to a network, wherein the device includes a first interface for connecting the device to the computing device. A second interface connects the device to the network; and, a third interface wirelessly connects the device to a power source. A sensor connected to the third interface measures wireless power to the computing device.

Still another embodiment of the invention provides a computing device having a first interface for connecting the computing device to a network. A second interface wirelessly connects the computing device to a power source; and, a sensor connected to the second interface measures wireless power to the computing device. A processor connected to the sensor compares the wireless power to the computing device to a threshold to determine whether the computing device should be decommissioned.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 illustrates a decision grid according to an embodiment of the invention;

FIG. 2 illustrates a device for monitoring activity of a computing device wirelessly connected to a network according to an embodiment of the invention;

FIG. 3 illustrates a computing device that is wirelessly connected to a network according to an embodiment of the invention;

FIG. 4 illustrates a device for monitoring activity of a computing device connected to a network according to an embodiment of the invention;

FIG. 5 illustrates a computing device connected to a network according to an embodiment of the invention;

FIG. 6 is a flow diagram illustrating a method for monitoring activity of a computing device wirelessly connected to a network according to an embodiment of the invention;

FIG. 7 is a flow diagram illustrating a method for monitoring activity of a computing device wirelessly connected to a network according to another embodiment of the invention; and

FIG. 8 illustrates a computer program product according to an embodiment of the invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

At least one embodiment of the invention provides a system that includes a sensor (e.g., smart RFID tag) that is inserted into a wireless network adapter and/or a wireless power supply, where the sensor measures the amount of network traffic and/or electricity going to a server (also referred to herein as a “computing device”, “box”, or “asset”). In at least one embodiment, the wireless network includes Wi-Fi, Bluetooth, Worldwide Interoperability for Microwave Access (Wi-Max), and/or cell phone mobile communications (e.g., 3G, 4G). For wireless power/electricity, another sensor can be used to monitor the consumption or integration within the wireless power adapter. Data can be sent from the sensor(s) along with a server identification number (e.g., RFID number) to a historical repository at predetermined time intervals (e.g., as defined by the RFID tag). Using this information, the system can determine if the server is being used or if it is a good candidate for decommission. As used herein, the term “decommission” (also referred to herein as “sunset”) refers to the termination of service, shutdown, and/or isolation of a computing device.

In at least one embodiment, a network sensor (e.g., RFID adapter) is installed on the wireless adaptor that is attached to the computing device. The network sensor can aggregate the network activity information from the wireless adaptor, where the network activity information can include the amount of network traffic, the type of network traffic (e.g., Internet Control Message Protocol (ICMP), User Datagram Protocol (UDP)/Transmission Control Protocol (TCP), port), and computing device information, such as Media Access Control address (MAC address) and/or Internet Protocol addresses (IP addresses). The network activity information can be used to determine who is using the computing device and/or who owns the computing device.

Thus, an embodiment of the invention provides a sensor to monitor power consumption and network activity in a wireless environment to aid in determining if a server is being used without logging into the device (e.g., console access) or having credentials displayed on the device. The sensor can monitor power consumption and network activity over time such that statistics of data flow and usage can be gathered over time and analyzed. Provisioning can be put in place to determine if a device is inactive versus whether the device has lost connectivity/pairing with a parent device.

At least one embodiment of the invention positions one or more sensors in the path of the electrical and/or network connections to a server. In one embodiment, the sensor is inserted between the server and the power and/or network source. In another embodiment, the sensor is connected to the server, wherein the sensor detects network traffic and power consumption of the server through the server's shielding. The sensor can be integrated with one or more wireless adaptors, where the sensor can be associated wirelessly with unique information about the server (e.g., RFID ID, physical location information, machine type, model type, serial number). The sensor can be programmed to capture a variety of data and send the data (e.g., wirelessly) to a database or information warehouse. The sensor can also be programmed to send the data continuously or to only send the data when it falls below a predetermined level or above a predetermined level.

Network traffic and/or power consumption falling below a predetermined level may indicate that the server is idle. If the database or information warehouse has scripts running against it, where the server is below a threshold for a period of time, it may be determined that the server is no longer being used and would be a good candidate for decommissioning. The removal of an unused server from a network or data center may enable raised floor savings (or equivalent lower bandwidth wireless networks, such as Bluetooth) and energy. By having historical data collected and stored for select items, such as IP and/or MAC addresses, a possible upstream or downstream dependency may be identified, which can further assist in determining whether a server should be decommissioned. Additionally, the historical data may assist in identifying associated tape libraries, external attached storage, and/or other device(s) that may also be decommissioned at the same time.

In some circumstances, the wireless pairing between child and parent devices (e.g., wireless router) may be susceptible to loss of connectivity. The network traffic and/or power to the computing device (i.e., child node) and/or from the computing device can be monitored at the computing device so that loss of connectivity can be detected and accounted for in the decision logic. In at least one embodiment, when a computing device is found to have lost pairing with the parent node (network provider), the computing device's lack of network activity and/or power consumption will not flag it for decommissioning.

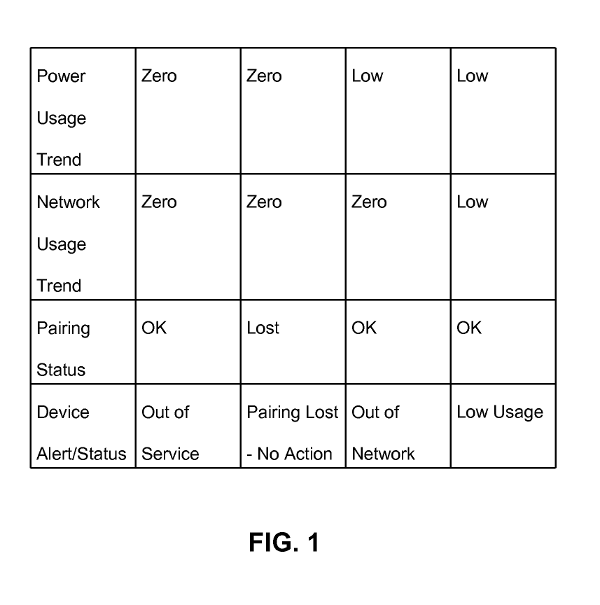

FIG. 1 illustrates a decision grid according to an embodiment of the invention. For example, a computing device with “OK” pairing status (e.g., wireless connectivity) and no power and network usage is identified as “Out of Service”. A computing device with “Lost” pairing status and no power and network usage is identified as “Pairing Lost—No Action”. A computing device with “OK” pairing status, low power usage, and zero network usage is identified as “Out of Network”. A computing device with “OK” pairing status, low power usage, and low network usage is identified as “Low Usage”.

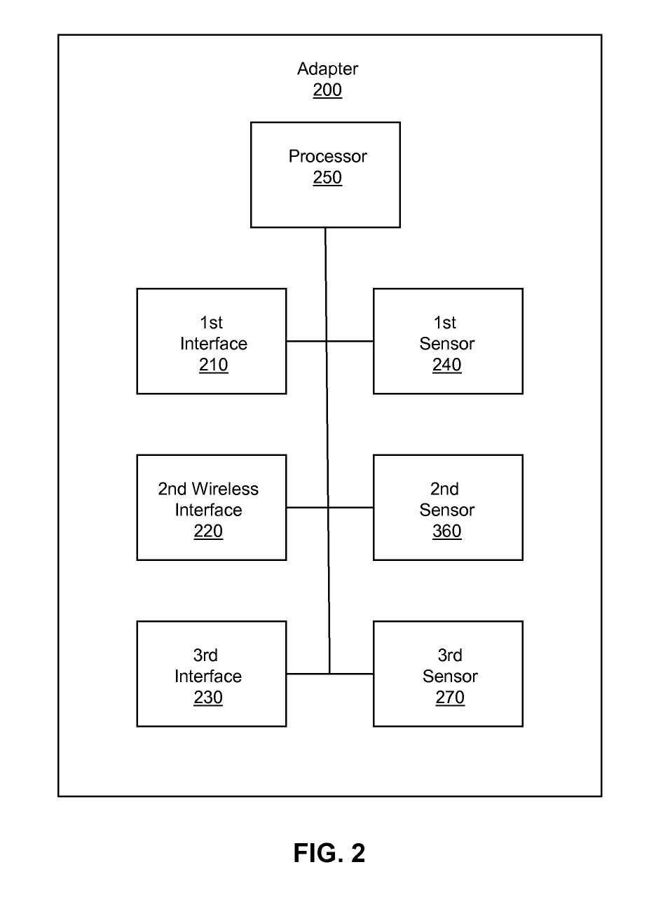

FIG. 2 illustrates a device 200 (also referred to herein as an “adapter”) for monitoring activity of a computing device C (also referred to herein as a “server”, “box”, or “asset”) wirelessly connected to a network according to an embodiment of the invention. In at least one embodiment, the computing device C is a server in a datacenter. The device 200 includes a first interface 210 for connecting the device to the computing device C, and a second interface 220 for wirelessly connecting the device to the network. As used herein, the term “connected” includes operationally connected, logically connected, in communication with, physically connected, engaged, coupled, contacts, linked, affixed, and attached.

The device 200 also includes a third interface 230 for connecting the device to a power source. In at least one embodiment, the third interface is a wireless power receiver, and the power source is a wireless power source. A sensor 240 is connected to the second interface 220, wherein the sensor 240 measures wireless network traffic to the computing device C and/or wireless network traffic from the computing device C. The network traffic to and/or from the computing device C can be measured at predetermined time intervals (e.g., hourly, daily, monthly). The sensor 240 in a further embodiment can also identify the device identifier (e.g., the device identification or serial number) of a device D accessing the computing device C (e.g., a client computer accessing the server). In another embodiment, the sensor 240 can identify the protocol used by the device D (e.g., client computer) to access the computing device C (e.g., server).

The device 200 further includes a processor 250 connected to the sensor 240, wherein the processor 250 compares the network traffic to the computing device C and/or the network traffic from the computing device C to one or more thresholds to determine whether the computing device C should be decommissioned. For example, if the processor 250 determines that the network traffic from the computing device C (e.g., 2 megabytes/day) is below a first threshold (e.g., 10 megabytes/day), then the processor 250 determines that the computing device C should be decommissioned. In another example, if the processor 250 determines that the total network traffic to and from the computing device C (e.g., 30 megabytes/day) is above a second threshold (e.g., 10 megabytes/day), then the processor 250 determines that the computing device C should not be decommissioned. In at least one embodiment, the processor 250 is external to the device 200.

In at least one embodiment of the invention, the device 200 further includes a second sensor 260 connected to the third interface 230, wherein the second sensor 260 measures the power consumption of the computing device C. The power consumption of the computing device C can be measured at predetermined time intervals (e.g., hourly, daily, monthly). The processor 250 can be connected to the second sensor 260 so that the processor 250 can compare the power consumption of the computing device C to a power threshold to determine whether the computing device C should be decommissioned. For example, if the processor 250 determines that the power consumption of the computing device C (e.g., 50 kilowatt hours/biweekly) is below a power threshold (e.g., 100 kilowatt hours/biweekly), then the processor 250 determines that the computing device C should be decommissioned. In a further embodiment, the third interface 230 and/or second sensor 260 are omitted from the device 200.

A third sensor 270 can also be connected to the processor 250, wherein the third sensor 270 (e.g., an RFID sensor) identifies the computing device C. The device 200 can also include a wireless communications module 280 that wirelessly transmits data from the processor 250, first sensor 240, second sensor 260, and/or third sensor 270 to an external device.

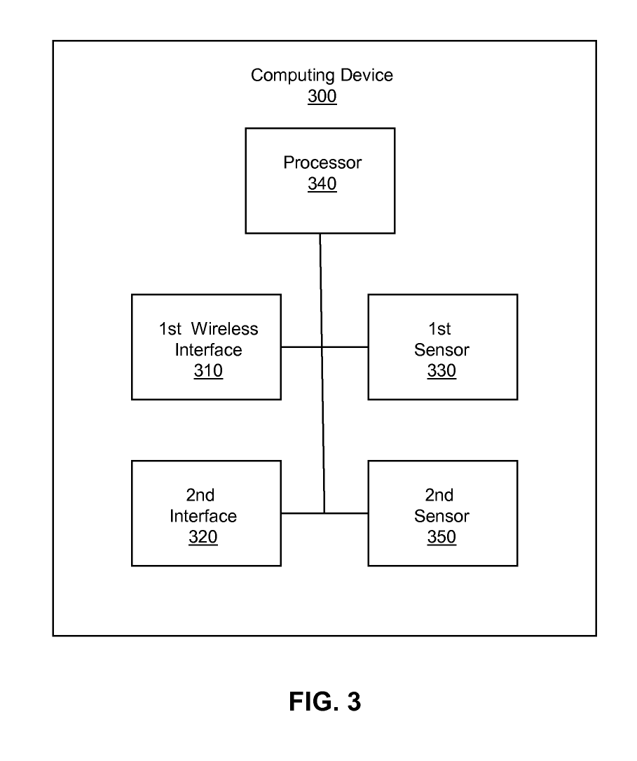

FIG. 3 illustrates a computing device 300 that is wirelessly connected to a network according to an embodiment of the invention. In at least one embodiment, the computing device 300 is a server in a datacenter. The computing device 300 includes a first interface 310 for wirelessly connecting the computing device 300 to the network, and a second interface 320 for connecting the computing device 300 to a power source. In at least one embodiment of the invention, the second interface 320 is a wireless power receiver, and the power source is a wireless power source.

A sensor 330 is connected to the first interface 310, wherein the sensor 330 measures the wireless network traffic to the computing device and/or the wireless network traffic from the computing device. In a further embodiment, the sensor 330 can also identify the device identifier of a device D (e.g., client computer) accessing the computing device 300, and/or a protocol used by the device D to access the computing device 300. In at least one embodiment of the invention, a second sensor 350 is connected to the second interface 320, wherein the second sensor 350 measures power consumption of the computing device 300.

A processor 340 is connected to the sensor 330, wherein the processor 340 compares the network traffic to the computing device 300 and/or the network traffic from the computing device 300 to one or more network traffic thresholds to determine whether the computing device 300 should be decommissioned. For example, if the processor 340 determines that the network traffic from the computing device 300 (e.g., 2 megabytes/week) is below a first threshold (e.g., 10 megabytes/week), then the processor 340 determines that the computing device 300 should be decommissioned.

The processor 340 can also be connected to the second sensor 350, wherein the processor 340 compares the power consumption of the computing device 300 to a power threshold to determine whether the computing device 300 should be decommissioned. For example, if the processor 340 determines that the power consumption of the computing device 300 (e.g., 200 kilowatts/hour) is above a power threshold (e.g., 100 kilowatts/hour), then the processor 340 determines that the computing device 300 should not be decommissioned.

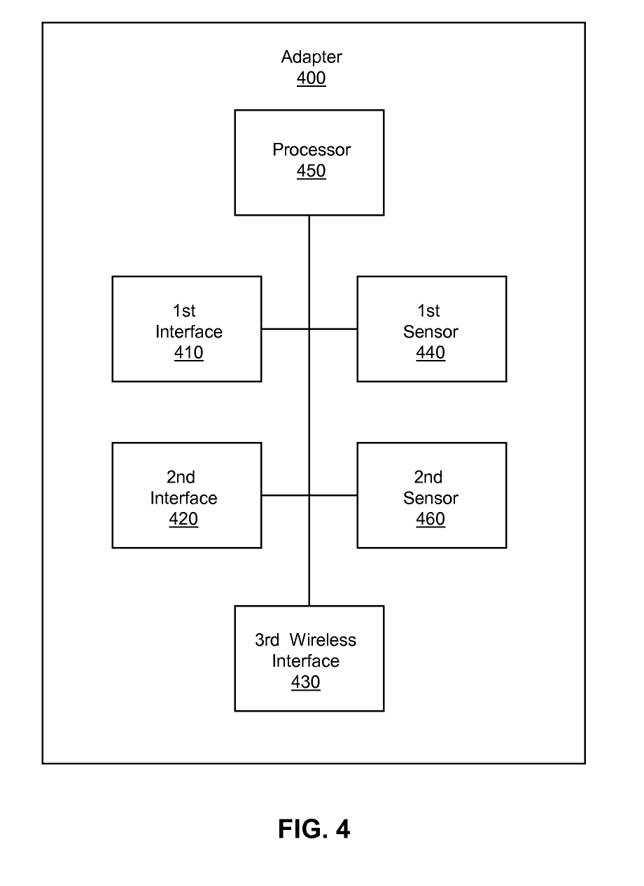

FIG. 4 illustrates a device 400 (also referred to herein as an “adapter”) for monitoring activity of a computing device C connected to a network according to an embodiment of the invention. The device 400 includes a first interface 410 for connecting the device 400 to the computing device C, and a second interface 420 for connecting the device 400 to the network. The second interface 420 can be a wireless network receiver, wherein the network is a wireless network. In another embodiment, the device 400 is connected to the network via a network cable. A third interface 430 (e.g., a wireless power receiver) wirelessly connects the device 400 to a power source.

A sensor 440 is connected to the third interface 430, wherein the sensor 440 measures the wireless power to the computing device C. The sensor can also identify the device identifier of a device D (e.g., client computer) accessing the computing device C (e.g., server), and/or the protocol used by the device D to access the computing device C.

A processor 450 is connected to the sensor 440, wherein the processor 450 compares the measured wireless power to the computing device C to a power threshold to determine whether the computing device C should be decommissioned. For example, if the processor 450 determines that the power consumption of the computing device C (e.g., 2 kilowatt hours/day) is below a power threshold (e.g., 4 kilowatt hours/day), then the processor 450 determines that the computing device C should be decommissioned.

A second sensor 460 can be connected to the second interface 420, wherein the second sensor 460 measures the wireless network traffic to the computing device C and/or the wireless network traffic from the computing device C. The processor 450 can compare the wireless network traffic to the computing device C and/or the wireless network traffic from the computing device C to one or more network traffic thresholds to determine whether the computing device C should be decommissioned.

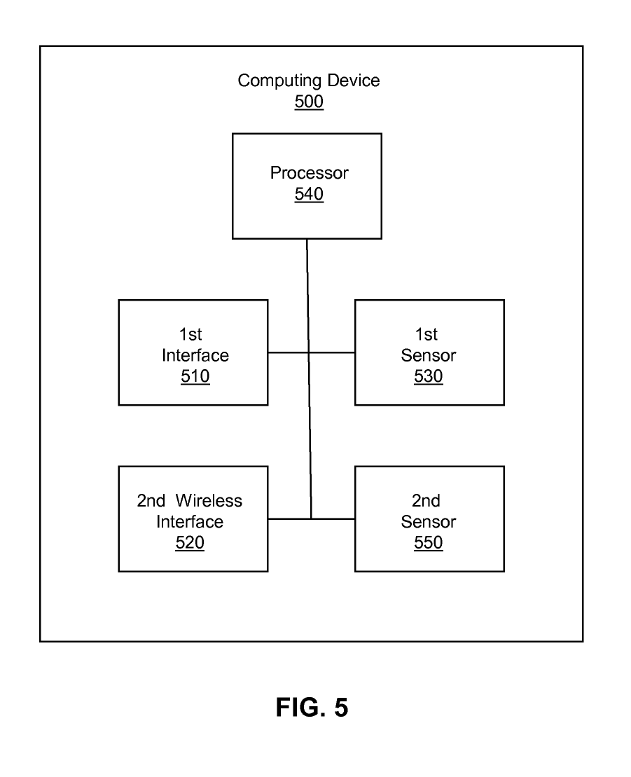

FIG. 5 illustrates a computing device 500 connected to a network according to an embodiment of the invention. The computing device 500 includes a first interface 510 for connecting the computing 500 device to the network, and a second interface 520 for wirelessly connecting the computing device 500 to a power source. Specifically, the second interface 520 is a wireless network receiver, and the network is a wireless network.

A sensor 530 is connected to the second interface 520, wherein the sensor 530 measures wireless power to the computing device 500. The sensor 530 can also identify the device identifier of a device D accessing the computing device 500, and the protocol used by the device D to access the computing device 500.

A processor 540 is connected to the sensor 530, wherein the processor 540 compares the wireless power to the computing device 500 to a power threshold to determine whether the computing device should be decommissioned. For example, if the processor 540 determines that the power consumption of the computing device 500 (e.g., 300 kilowatt hours/month) is above a power threshold (e.g., 200 kilowatt hours/month), then the processor 540 determines that the computing device 500 should not be decommissioned.

A second sensor 550 can be connected to the first interface 510, wherein the second sensor 550 measures the wireless network traffic to the computing device 500 and/or the wireless network traffic from the computing device 500. The processor 540 can compares the wireless network traffic to the computing device 500 and/or the wireless network traffic from the computing device 500 to one or more network traffic thresholds to determine whether the computing device should be decommissioned.

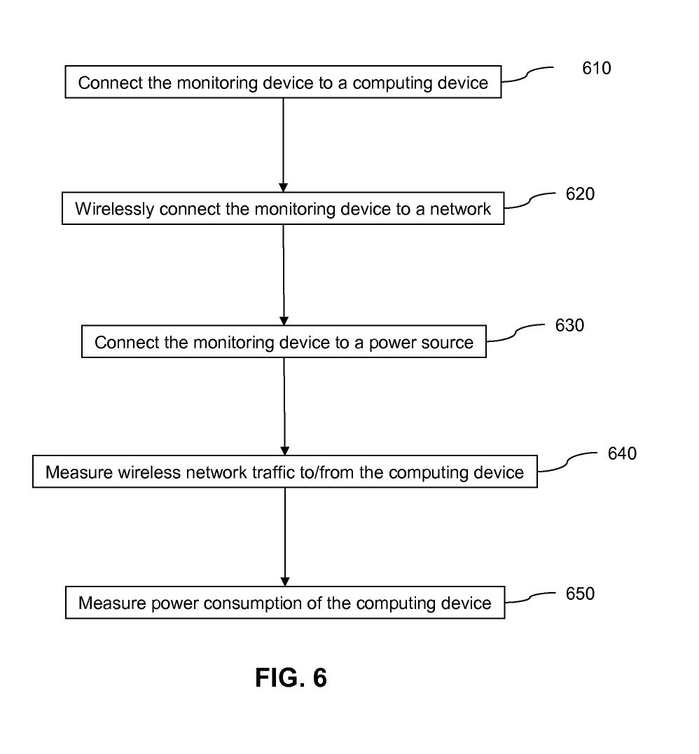

FIG. 6 is a flow diagram illustrating a method for monitoring activity of a computing device (also referred to herein as a “server”, “box”, or “asset”) wirelessly connected to a network according to an embodiment of the invention. A monitoring device (also referred to herein as the “device” or “adapter”) is connected to the computing device 610. The monitoring device is wirelessly connecting to the network 620; and, the monitoring device is connected to a power source 630. In at least one embodiment, a wireless power receiver of the monitoring device is wirelessly connected to a wireless power source.

Wireless network traffic to the computing device and/or wireless network traffic from the computing device is measured (e.g., by a sensor of the monitoring device) 640. The network traffic to the computing device and/or the network traffic from the computing device can be compared (e.g., with a processor of the monitoring device) to one or more thresholds to determine whether the computing device should be decommissioned.

In at least one embodiment of the invention, power consumption of the computing device is measured (e.g., with a second sensor of the monitoring device) 650. The power consumption of the computing device can be compared to a threshold (e.g., with the processor) to determine whether the computing device should be decommissioned. The wireless network traffic to the computing device measurements, wireless network traffic from the computing device measurements, and/or power consumption of the computing device measurements can be wirelessly transmitted to an external device (e.g., with a wireless communications module of the monitoring device).

At least one embodiment of the invention identifies a device identifier of a device accessing the computing device and/or one or more protocols used by the device to access the computing device. Furthermore, the computing device can be identified with an RFID sensor of the monitoring device.

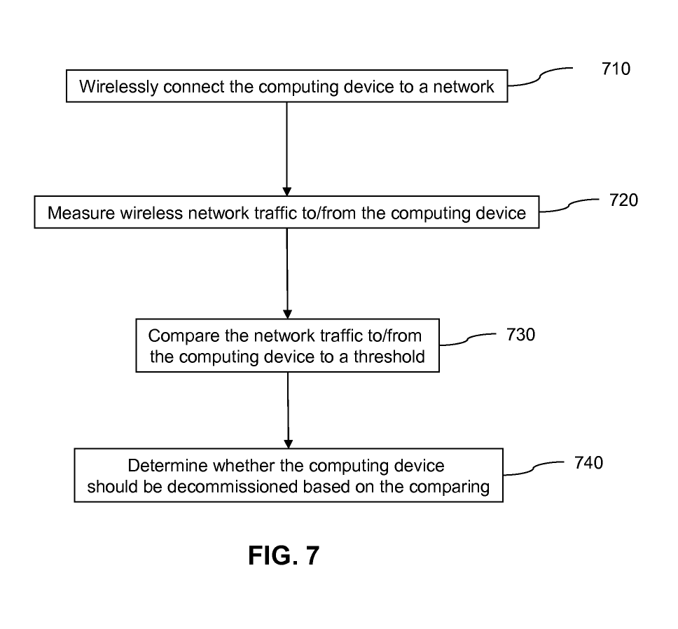

FIG. 7 is a flow diagram illustrating a method for monitoring activity of a computing device according to another embodiment of the invention, wherein the computing device is wirelessly connecting to a network 710. Wireless network traffic to the computing device and/or wireless network traffic from the computing device are measured by a sensor 720. The network traffic to the computing device and/or the network traffic from the computing device are compared to one or more network traffic thresholds 730. A processor determines whether the computing device should be decommissioned based on the comparing of the network traffic to the computing device and/or the network traffic from the computing device to the threshold 740.

In at least one embodiment of the invention, a wireless power receiver of the computing device is wirelessly connected to a wireless power source. Power consumption of the computing device can be measured with a sensor; and, the processor can compare the measured power consumption of the computing device to a power threshold. The processor can determine whether the computing device should be decommissioned based on the comparison of the power consumption of the computing device to the power threshold. In at least one embodiment, the sensor can also identify a device identifier of a device accessing the computing device and/or a protocol used by the device to access the computing device.

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

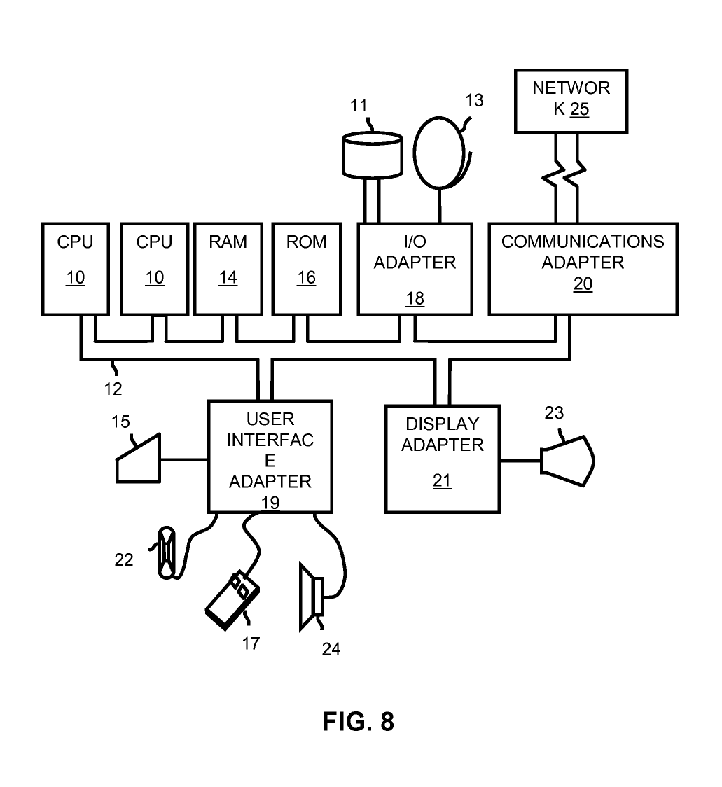

Referring now to FIG. 8, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of at least one other feature, integer, step, operation, element, component, and/or groups thereof

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for monitoring activity of a computing device wirelessly connected to a network, said method comprising:
connecting a monitoring device to the computing device;
wirelessly connecting the monitoring device to the network;
connecting the monitoring device to a power source; and
measuring at least one of wireless network traffic to the computing device and wireless network traffic from the computing device.

2. The method according to claim 1, wherein said connecting of the monitoring device to a power source includes wirelessly connecting a wireless power receiver of the monitoring device to a wireless power source.

3. The method according to claim 1, further comprising identifying at least one of:
a device identifier of a device accessing the computing device; and
at least one protocol used to access the computing device.

4. The method according to claim 1, further comprising comparing at least one of the network traffic to the computing device and the network traffic from the computing device to at least one threshold to determine whether the computing device should be decommissioned.

5. The method according to claim 1, further including measuring power consumption of the computing device.

6. The method according to claim 5, further comprising comparing the power consumption of the computing device to a threshold to determine whether the computing device should be decommissioned.

7. The method according to claim 5, further comprising wirelessly transmitting at least one of wireless network traffic to the computing device measurements, wireless network traffic from the computing device measurements, and power consumption of the computing device measurements to an external device.

8. The method according to claim 1, further comprising identifying the computing device with an RFID sensor.

9. A method for monitoring activity of a computing device wirelessly connected to a network, said method comprising:
connecting a monitoring device to the computing device;
wirelessly connecting the monitoring device to the network;
wirelessly connecting the monitoring device to a wireless power source;
measuring at least one of wireless network traffic to the computing device and wireless network traffic from the computing device; and
comparing at least one of the network traffic to the computing device and the network traffic from the computing device to at least one threshold to determine whether the computing device should be decommissioned.

10. The method according to claim 9, further comprising identifying at least one of:
a device identifier of a device accessing the computing device; and
at least one protocol used to access the computing device.

11. The method according to claim 9, further including measuring power consumption of the computing device.

12. The method according to claim 11, further comprising comparing the power consumption of the computing device to a threshold to determine whether the computing device should be decommissioned.

13. The method according to claim 11, further comprising wirelessly transmitting at least one of wireless network traffic to the computing device measurements, wireless network traffic from the computing device measurements, and power consumption of the computing device measurements to an external device.

14. The method according to claim 9, further comprising identifying the computing device with an RFID sensor.

15. A method for monitoring activity of a computing device wirelessly connected to a network, said method comprising:
connecting a monitoring device to the computing device;
wirelessly connecting the monitoring device to the network;
wirelessly connecting the monitoring device to a wireless power source;
measuring at least one of wireless network traffic to the computing device and wireless network traffic from the computing device; and
wirelessly transmitting at least one of wireless network traffic to the computing device measurements and wireless network traffic from the computing device measurements to an external device.

16. The method according to claim 15, further comprising identifying at least one of:
a device identifier of a device accessing the computing device; and
at least one protocol used to access the computing device.

17. The method according to claim 15, further comprising comparing at least one of the network traffic to the computing device and the network traffic from the computing device to at least one threshold to determine whether the computing device should be decommissioned.

18. The method according to claim 15, further including:
measuring power consumption of the computing device; and
comparing the power consumption of the computing device to a threshold to determine whether the computing device should be decommissioned.

19. The method according to claim 18, further comprising wirelessly transmitting power consumption of the computing device measurements to an external device.

20. The method according to claim 15, further comprising identifying the computing device with an RFID sensor.

21. A method for monitoring activity of a computing device wirelessly connected to a network, said method comprising:
wirelessly connecting the computing device to the network;
measuring at least one of wireless network traffic to the computing device and wireless network traffic from the computing device;
comparing at least one of the network traffic to the computing device and the network traffic from the computing device to at least one threshold; and
determining whether the computing device should be decommissioned based on said comparing of the at least one of the network traffic to the computing device and the network traffic from the computing device to the at least one threshold.

22. The method according to claim 21, further comprising wirelessly connecting a wireless power receiver of the computing device to a wireless power source.

23. The method according to claim 21, further comprising identifying at least one of:
a device identifier of a device accessing the computing device; and
at least one protocol used to access the computing device.

24. The method according to claim 21, further comprising measuring power consumption of the computing device.

25. The method according to claim 24, further comprising:
comparing the power consumption of the computing device to a power threshold; and
determining whether the computing device should be decommissioned based on said comparing of the power consumption of the computing device to the power threshold.
